(19) United States
(12) Patent Application Publication
(10) Pub. No.: US 2013/0001336 A1
(43) Pub. Date: Jan. 3, 2013

(54) BALED BIOMASS PROCESSING SYSTEM AND METHOD

(76) Inventor: Mark Gerlinger Lyman, Salem, OR (US)

(21) Appl. No.: 13/540,412

(22) Filed: Jul. 2, 2012

Related U.S. Application Data
(60) Provisional application No. 61/503,610, filed on Jun. 30, 2011.
(60) Provisional application No. 61/505,444, filed on Jul. 7, 2011.
(60) Provisional application No. 61/534,567, filed on Sep. 14, 2011.
(60) Provisional application No. 61/621,869, filed on Apr. 9, 2012.

(51) Int. Cl. B02C 23/08; B02C 23/02

(52) U.S. Cl. 241/24.21; 241/25; 241/28; 241/29

(57) ABSTRACT

A method for automated destringing and breaking down of baled biomass material using limited manual labor is disclosed. The method includes selecting and moving one bale of biomass material from a stack of bales to an automated destringing station where the string is removed from that bale. The bale is then lined up next in line with previously processed destrung bales and advanced along a continuous process line through a bale chopper that breaks the biomass material down into useful pieces for further processing at the facility. In a preferred embodiment an automated initial quality control evaluation step can be provided with a bale rejection system operated on detected non-conforming bales before they are destrung.

### CROSS REFERENCE TO RELATED APPLICATIONS

This application claims priority to U.S. provisional patent application Ser. No. 61/503,610 filed on Jun. 30, 2011, Ser. No. 61/505,444 filed on Jul. 7, 2011, Ser. No. 61/534,567 filed on Sep. 14, 2011 and Ser. No. 61/621,869 filed on Apr. 9, 2012, all of the disclosures of which are hereby incorporated by reference.

### FIELD

The present disclosure relates to a system and method for automated processing of baled biomass materials.

### BACKGROUND

Biological material used as an energy source is commonly referred to as “biomass.” It can be used directly as an energy source, or more commonly, it is converted into other energy products such as biofuel. For example, biomass, such as corn leaves and stalks, sugar cane, and the like, can be ground up and fermented to produce ethanol.

Demand for biofuels produced from renewable biomass materials is increasing. Accordingly, the demand for biomass material has also increased significantly. As a result, a huge volume of biomass material must be regularly collected from the places where it was grown or processed, and it must be efficiently transported using conventional transportation methods such as trucks and trains to biofuel processing facilities.

The vast majority of biomass materials are transported and stored as very large tightly compressed bales weighing several tons with each bale wrapped tightly in string or the like. These bales are usually stacked on top of each other two or three bales high and loaded on open air trucks or trains for transport. At the biofuel processing facility, each bale must be unloaded, unstrung, decompressed, cleaned and broken down into small pieces before the biomass in the bale can begin being converted into biofuel.

Known methods and structures for breaking down these bales are labor intensive, inefficient and sometimes even dangerous. Moreover, these methods and structures may unduly limit the rate at which some biofuel processing facilities can produce biofuels.

### SUMMARY OF THE INVENTION

The present invention overcomes these and other problems with these known methods and structures. It includes a system and method for selecting and moving one bale of biomass material from a stack of bales to an automated destringing station where the string is removed from that bale without manual labor. The bale is then lined up next in line with previously processed destrung bales and advanced along the continuous process line through a bale chopper that breaks the biomass material down into useful pieces for further processing at the facility.

In a preferred embodiment, the system also includes an initial quality control evaluation step prior to the destringing station that allows the quality of each bale to be inspected prior to being destrung. The system may also include structures for removing any rejected bales before they enter the destringing station. In addition, a screening and cleaning system after the bale chopping step allows dirt and other fine materials to be removed from the broken down pieces and any oversized pieces remaining to be further broken down prior to passing further into the processing facility.

### DRAWINGS

The drawings described herein are for illustrative purposes only of selected embodiments and not all possible implementations, and are not intended to limit the scope of the present disclosure.

FIG. 1 is a schematic side view of a process line showing the possible steps for processing stacks of baled biomass in conformance with an embodiment of the present invention.

FIG. 2 is an isometric view of a conventional bale 100 of biomass material that is wrapped with string 102 to facilitate storage and shipment.

FIG. 3 is an isometric view of a stack of bales 100 of biomass material of FIG. 2 showing a possible orientation for efficient storage and transport on a vehicle or the like.

FIG. 4 is a flow chart showing the process of FIG. 1.

### DETAILED DESCRIPTION

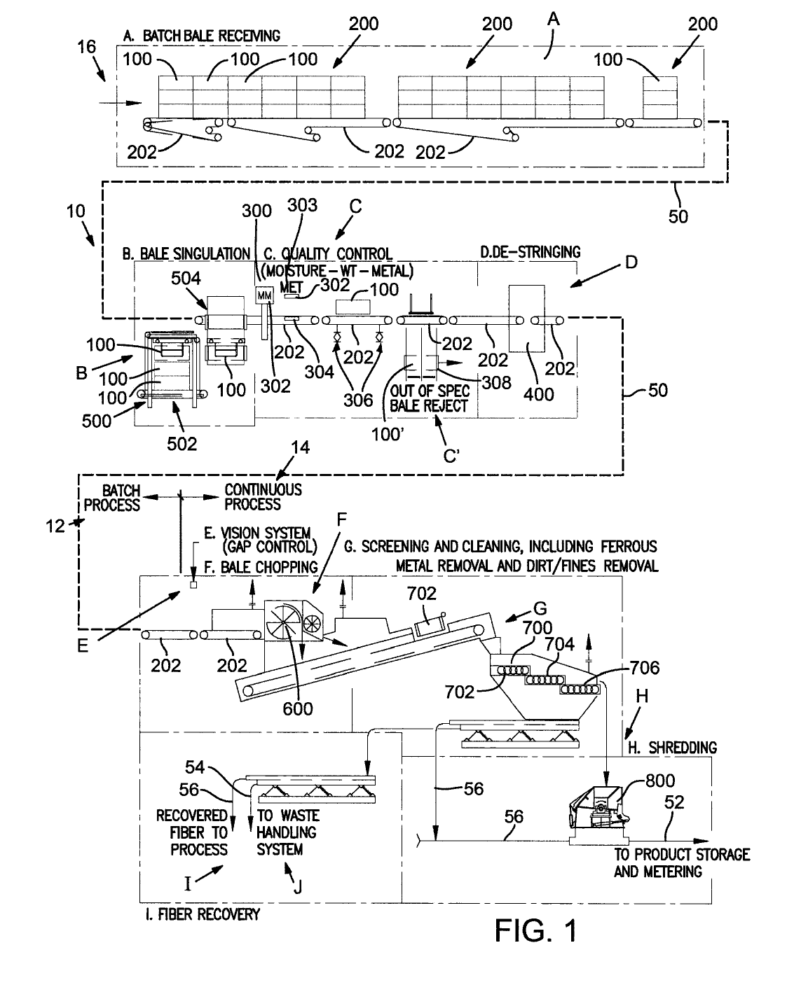

FIGS. 1-4 illustrate a baled biomass processing system 10 that individually selects and “destrings” a bale 100 of biomass material, preferably in a batch process 12, before forwarding it through a continuous flow process 14 for breaking down the biomass material within the bale and delivering the broken down biomass to a facility for further processing.

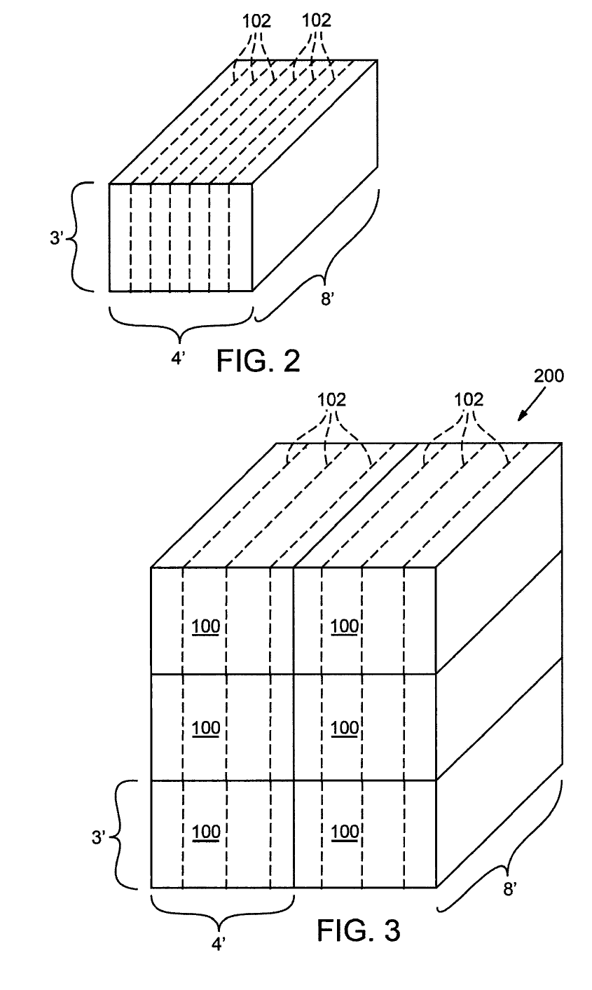

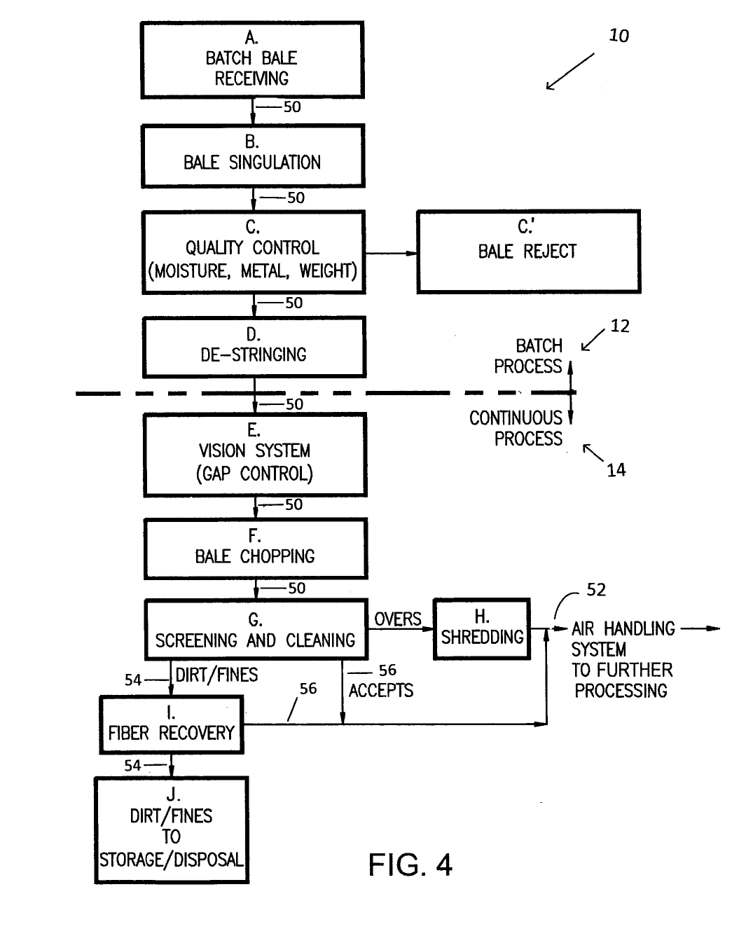

As shown in FIGS. 2 and 3, a bale of biomass 100, such as cornstalks, other plant or tree waste, or other organic fuel material that is wrapped in string 102 is delivered to a processing facility where it is usually stored with other bales 100 in stacks 200. Referring to FIGS. 1 and 4, bales 100 enter a processing line at point 16 in STEP A and are advanced toward an area in which STEP B is performed. Preferably, sensors in communication with a computer system detect the location of the bales 100 and the computer system activates driving devices 202 such as conveyor belts or the like in communication with the computer system to advance the bales 100 forward as needed.

In STEP B, each bale 100 in the stack 200 is separated out by a bale singulator 500. The bale singulator 500 preferably includes sensors in communication with the computer system to allow automatic singulation of each bale. For example, the stack 200 enters the singular. An elevator portion 502 along the path raises the stack 200 so as to align the top most bales within the stack with the process path. A bale pinch system grabs the top two bales in the stack and moves them in the direction along the process path to a singulating transfer deck 504. A horizontal mover moves each bale 100 of the two bales horizontally so that each bale one-at-a time enters into the process path toward STEP C. While this is taking place, the elevator portion can raise the next highest bales in the stack into position for movement onto the singulating transfer deck 508. Alternatively, singulation of individual bales 100 from the stack 200 at this step can be performed with conventional structures such as an operator controlled fork lift, crane system, or the like.

Preferably, STEP C involves transferring the bale 100 from the singulator step to STEP D and it includes at least one quality measure 300 being performed on the bale 100 as it advances toward STEP D. For example, conventional sensors in communication with the computer system can determine the moisture content 302, weight 304, and/or metal content 306 of each bale 100 as it advances toward STEP D on one or more driving devices 202. More preferably, the path includes bale rejection structures 308 (STEP C′) for removing any bales that fail to comply with one or more detected pre-determined quality standards detected by the quality measuring equipment present. The bale rejection structures preferably remove the non-compliant bales 100′ from the flow path 50 without stopping the advancement of other bales 100 along the flow path 50, say for example, by sliding them out of the path to a holding area where they can be subsequently removed from the area.

Compliant bales 100 advance along the flow path to STEP D, where they are destrung, preferably by an automated destringer 400. One such device is disclosed in U.S. provisional patent application No. 61/505,444, the disclosure of which is hereby incorporated by reference. The destringer 400 includes a cutting and winding system along a conveyor path. Each bale 100 is positioned one at a time over the cutting and winding system. The upper portion of the cutting and winding system is lowered over the bale 100 so that grabber brackets hold the lines 102 in place. A retractable blade comes up from the floor of the conveyor to slice the lines 102. A grabber moves along the upper portion toward a winder motor. Guides urge the lines around retractable tines in the motor assembly. A motor rotates the tines the cut lines are wrapped around them. Once the lines are completely wrapped around the tines, the tines retract to release the coils cut lines. The lineless bale then moves along the flow path to STEP E.

STEP E preferably includes an aligning system for timing and aligning the bales to start a continuous flow 14 of biomass material for the remaining steps of the process. Preferably, vision sensors in communication with the computer system monitor and detect the bales 100 entering this step and the gaps between them, and it modulates the driving devices 202 as needed to align and maintain continuous flow of biomass material as needed towards STEP F.

Compressed and unbroken-down biomass from the destrung bale 100 enter a bale chopper 600 in STEP F. One known bale chopper 600 is disclosed in U.S. provisional patent application Ser. No. 61/621,869, the disclosure of which is hereby incorporated by reference. The bale chopper 600 breaks down the biomass and delivers a continuous flow of broken down biomass to STEP G.

STEP G involves screening and cleaning the broken down biomass using a screening system 700. One known biomass screening system 700 is disclosed in U.S. provisional patent application Ser. No. 61/534,567, the disclosure of which is incorporated by reference. Preferable the screening system separates out any loose metal by placing a magnet 702 in proximity to the flow of biomass. The screening system 700 then deposits and conveys the biomass through an increasingly more open screening system so that fine particles are removed in a first portion 704 of the screening process with larger sized particles moving towards a second screening and third screening portions (706, 708, respectively), and any remaining larger portions are conveyed toward STEP H.

In STEP H, remaining larger portions of biomass are run through a shredder 800 where they are further broken down before being transmitted via path 52 for further processing and/or storage for future use at the processing facility.

The screening system 700 system preferably includes separate paths for transmitting filtered out small particles like dirt (path 54) and the like to a waste handling system (STEP J), and medium-sized materials, which are recoverable biomass fiber, to join the final product path via path 56 for further processing and/or storage at the processing facility.

Having fully described the baled biomass processing method herein, it can be appreciated that steps can be added, modified, or removed as needed without compromising the scope of the claimed invention. For example, the structures and method disclose herein will work equally well with a plurality of flow lines established. Such a system could include by-pass structures that allow biomass to be moved between the production lines as needed for equipment maintenance or to optimize flow through the system. Similarly, the sensors, driving devices and related equipment can be modified as needed to accommodate different sized and shaped bales of biomass, and the arrangement, location, order, number and type of quality testing stations can be adjusted as needed for a particular application of the system as needed.

Accordingly, the present disclosure is not intended to be limited to the embodiments shown herein, but is to be accorded the widest scope consistent with the principles and novel features of the invention as claimed below.

What is claimed is:

1. A method for breaking down bales of biomass material comprising the steps of:
receiving a plurality of bales of biomass material, each bale wrapped in line.
singulating a bale from the plurality of bales of biomass material to proceed down a flow path toward further processing;
a destringer automatically removing the line around the bale of biomass material defining a destrung bale of biomass material;
positioning the destrung bale of biomass material in a continuous flow path toward a bale chopper;
chopping the destrung bale of biomass in the bale chopper to define chopped biomass material;
transmitting the chopped biomass material to a screener;
screening the chopped biomass material to separate impurities, acceptably sized pieces of biomass material and oversized pieces of biomass material from each other;
shredding the oversized pieces of biomass material into acceptably sized pieces of biomass material; and,
transmitting the acceptably sized pieces of biomass material for further processing or storage.

2. The method for breaking down bales of biomass material of claim 1, wherein the singulating step includes an automatic singulator in communication with a computer system detecting and singulating one bale from a plurality of bales and advancing the one bale down the flow path.

3. The method for breaking down bales of biomass material of claim 1, further including the step of determining at least one quality characteristic of the bale singulated in the singulating step.

4. The method for breaking down bales of biomass material of claim 3, wherein said at least one quality in the determining at least one quality characteristic step is selected from the group consisting of the bale's weight, the bale's moisture content, and the bales metal content.

5. The method for breaking down bales of biomass material of claim 3, further including the step of removing a bale from the flow path when a predetermined quality characteristic is detected defining a rejected bale.

6. The method for breaking down bales of biomass material of claim 5, wherein the step of removing a bale from the flow path includes a system for sliding the rejected bale out of the flow path without compromising the flow of other bales along the flow path.

7. The method for breaking down bales of biomass material of claim 1, further including the step of the computer system automatically detecting and modulating the flow of destrung bales down the flow path to optimize the continuous flow of destrung bales down the flow path.

8. The method for breaking down bales of biomass material of claim 7, wherein the step of the computer system automatically detecting and modulating the flow of destrung bales includes the computer system in communication with a vision sensing system to detect the unstrung bales and the computer system modulating activation of a driving device to maintain continuous flow of the unstrung bales.

9. The method for breaking down bales of biomass material of claim 1, wherein said screening step includes removing metals from the biomass material by conveying the biomass material past a magnet.

10. The method for breaking down bales of biomass material of claim 1, wherein said screening step includes collecting impurities for storage and/or disposal.

11. The method for breaking down bales of biomass material of claim 1, wherein said chopping and said screening steps are a continuous process.
